(19) United States
(12) Patent Application Publication
(10) Pub. No.: US 2015/0149753 A1
(43) Pub. Date: May 28, 2015

(54) SERVER AND INSPECTING METHOD THEREOF

(71) Applicants: INVENTEC CORPORATION, Taipei (TW); Inventec (Pudong) Technology Corporation, Shanghai (CN)

(72) Inventors: Wei HUANG, Shanghai (CN); ZhongYing QU, Shanghai (CN); LAI KONG, Shanghai (CN)

(73) Assignees: INVENTEC CORPORATION, Taipei (TW); Inventec (Pudong) Technology Corporation, Shanghai (CN)

(21) Appl. No.: 14/162,568

(22) Filed: Jan. 23, 2014

(30) Foreign Application Priority Data
Nov. 25, 2013 (CN) 201310608696.1

(51) Int. Cl. G06F 11/22

(52) U.S. Cl. CPC G06F 11/2289
USPC 713/2

(57) ABSTRACT

Disclosed herein are a server and a inspecting method thereof. The server comprises a baseboard management controller, a field-replaceable unit coupled with the baseboard management controller, and a basic input/output system (BIOS). After the server is powered on, the BIOS starts running, performs power-on self-test for the server to generate current hardware configuration data, and obtains preset hardware configuration data from the field-replaceable unit through the baseboard management controller. The BIOS then determines whether the current and the preset hardware configuration data agree.

### CROSS-REFERENCE TO RELATED APPLICATIONS

This non-provisional application claims priority under 35 U.S.C. §119(a) on Patent Application No. 201310608696.1 filed in People's Republic of China on Nov. 25, 2013, the entire contents of which are hereby incorporated by reference.

### TECHNICAL FIELD

The present invention relates to server technology, particularly to a server and its inspecting method.

### BACKGROUND

After a server is powered up, its basic input/output system (BIOS) may perform power-on self-test (POST) for it to initialize the swarm of components on the motherboard and provide the necessary runtime environment for the operating system. The BIOS usually disables components that cannot be properly initialized during POST and records part of the POST results per System Management BIOS (SMBIOS) format. When the server enters into the operating system, the way for a user to access hardware information is to log in first remotely and locally parse SMBIOS through a capable utility program. It is inconvenient and inefficient. Moreover, data structures for hard disk drives, PCIe (Peripheral Component Interconnect Express) expansion cards, or other peripherals connected to the server are not defined in SMBIOS, and the identification of these hardware items is only available in software applications under the operating system.

### SUMMARY

In light of the above, the present invention discloses a server and an inspecting method for efficiently and conveniently monitoring and managing the server.

In the server inspecting method provided by this disclosure, a server is first started up, its BIOS beginning to operate. The BIOS performs a power-on self-test of the server to generate current hardware configuration data, and obtains preset hardware configuration data from a field-replaceable unit of the server through a baseboard management controller of the server, the field-replaceable unit coupled with the baseboard management controller. The BIOS then determines whether the current and the preset hardware configuration data match.

The server provided by this disclosure comprises a baseboard management controller for causing the server to start up, a field-replaceable unit coupled with the baseboard management controller, and a BIOS. The field-replaceable unit is adapted for storing preset hardware configuration data. The BIOS is adapted for performing a power-on self-test of the server to generate current hardware configuration data, obtaining preset hardware configuration data from the field-replaceable unit through the baseboard management controller, and determining whether the current and the preset hardware configuration data match.

In one embodiment, a storage place for storing the preset hardware configuration data is reserved in the FRU. In one embodiment, the BIOS further determines whether the FRU stores the preset hardware configuration data. When the FRU does not store the preset hardware configuration data, the BIOS stores the current hardware configuration data into the storage place. In one embodiment, when the current hardware configuration data and the preset hardware configuration data have at least one mismatch, the BIOS stores the current hardware configuration data into the storage place, replacing the preset hardware configuration data with the current hardware configuration data. In one embodiment, the BIOS records the mismatch into an event log through the BMC.

In short, the BIOS in the server and the inspecting method of the present invention is able to detect changes and anomalies in the server by comparing the current and the preset configuration data, facilitating highly efficient and convenient monitoring and management of the server hardware.

### BRIEF DESCRIPTION OF THE DRAWINGS

The present invention will become more fully understood from the detailed description given hereinbelow and the accompanying drawings which are given by way of illustration only and thus are not limitative of the present invention and wherein:

FIG. 1 is a high-level block diagram of a server, in accordance with one embodiment of the present invention.

FIG. 2 is a flowchart of a server inspecting method, in accordance with one embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

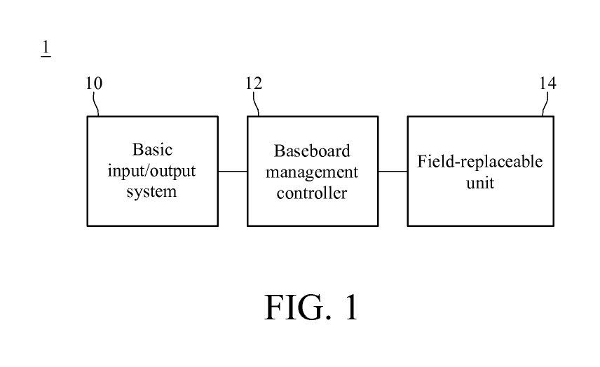

Please refer to FIG. 1. As shown in this high-level block diagram, in one embodiment, a server 1 comprises a basic input/output system (BIOS) 10, a baseboard management controller (BMC) 12, and a field-replaceable unit (FRU) 14 coupled with the BMC 12. To streamline the description, the central processing unit (CPU), volatile random-access memory (RAM) used by the CPU (e.g. a dual in-line memory module or DIMM), heat-dissipation modules, power supply, hard disk drives, RAID (redundant array of independent disks) card, sensors for the aforementioned hardware, etc that the server 1 may further include are not depicted in FIG. 1.

The BMC 12 is usually one part of the Intelligent Platform Management Interface (IPMI) of the server 1. As the processing core of the IPMI, the BMC 12 monitors sensors at multiple locations within the server 1 to get a handle of and automatically report the temperature, power stability, and other operational status of the server 1. The BMC 12 may also cause the server 1 to start up or shut down. The FRU 14 may be flash memory, other types of electrically erasable programmable read-only memory (EEPROM), or other non-volatile storage, coupled with the BMC 12 through an I²C (Inter-Integrated Circuit) or a SPI (Serial Peripheral Interface) bus.

The operation of the BIOS 10 involves the CPU, the volatile RAM, and a dedicated read-only memory where the program code of the BIOS 10 is stored. The CPU executes this program code so that the BIOS 10 works and performs the power-on self-test (POST) for the bootstrapping server 1. Generally speaking, the BIOS 10 can be seen as a function block that starts working after the server 1 is powered up. The coupling between the BIOS 10 and the BMC 12 may be, but not limited to, a LPC (Low Pin Count) bus.

The POST of the server 1 may include the BIOS 10 disabling cores found to be broken during the built-in self-test of the CPU, detecting and initializing the volatile RAM and disabling broken modules, scanning for peripheral hardware connected to the motherboard, distributing resource accordingly, and collecting relevant information based on the said steps, such as the number, health, manufacturer, model, and manufacture date of each component. Within the scope of this disclosure, the relevant information thus acquired is known as hardware configuration data or HCD.

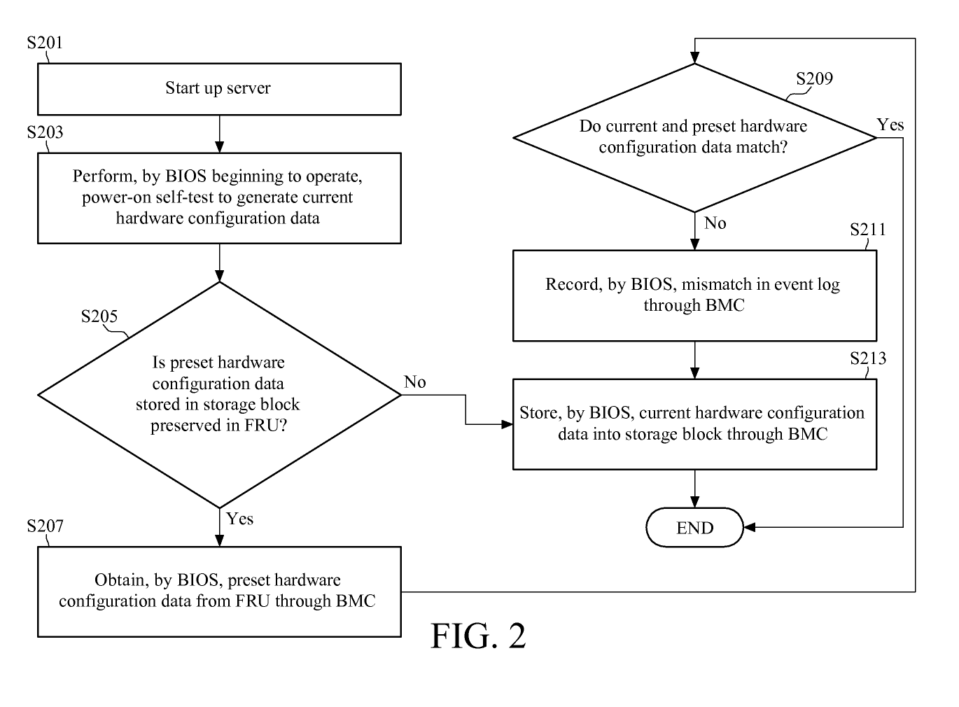

Please refer to FIG. 2 with regard to FIG. 1. As shown in this flowchart, the server 1 is turned on in step S201. In step S203, the BIOS 10 begins its operation and performs a POST to generate current HCD, as described in the previous paragraph. The generated HCD may be temporarily saved in the volatile RAM of the server 1. In steps S205 and S207, the BIOS 10 determines, through the BMC 12, whether preset HCD can be found in the FRU 14, and if so, tries to procure the preset HCD from the FRU 14 through the BMC 12. The preset HCD may be the HCD generated during (and current to) a previous booting of the server 1, or may be written into the FRU 14 by an external device according to, for example, a user-anticipated hardware configuration of the server 1. Whether the preset and the current HCD agree is verified by the BIOS 10 in step S209; if they match, the same hardware configuration is recorded by both HCD. Specifically, in step S205, the BIOS 10 determines whether the FRU 14 has stored a copy of HCD based on the reaction of the BMC 12. If not, the server 1 may be in its maiden run and no POST has ever been carried out, or the preset HCD in the FRU 14 has disappeared or been destroyed artificially or unexpectedly. In this case, the BIOS 10 may simply store the current HCD into the FRU 14 through the BMC 12 in step S213. If the answer to step S205 is positive, the BIOS 10 obtains the preset HCD from the FRU 14 through the BMC 12 in step S207, and in step S209 determines whether there is disagreement between the current and the preset HCD as a result of, say, a change in the hardware configuration of the server 1 or some malfunctioning hardware being disabled. Step S209 generally pertains to that the BIOS 10 compares the two bit strings representing the current and the preset HCD. If they match, the BIOS 10 may end the inspecting and continues other process of the POST, and prepare for the transfer of control of the server 1 to the operating system when the POST ends. If they do not, in one embodiment, the BIOS 10 records any mismatch in step S211 for future reference. In practice, the sensor event log (SEL, also known by various other names, e.g. system error log) of the BMC 12 may be employed to store items of disagreement found in step S209. Finally, the BIOS 10 executes step S213 and the rest of the bootstrapping process.

In one embodiment, “obtaining from the FRU 14” or “storing into the FRU 14” pertains to accessing a reserved storage place in the FRU 14 with the help of the BMC 12. The storage place is dedicated to the storage of HCD in a user-defined format. The storage of the current HCD into this storage place pertains to positioning or addressing the preset HCD conforming to the said format so that the current HCD, also conforming to the format, are completely covered by or replaced with the preset HCD.

That the format is user-defined, in addition to improving management flexibility, also provides a form of theft protection for the HCD. In other words, the HCD may well be a meaningless series of bits that cannot be parsed in the eyes of a malicious outsider. Of course, a reference format may be applied in the server 1 by default, as exemplified in the following Table 1:

TABLE 1

| | Name of | Length | |
|---|---|---|---|
| Hardware | Parameter | (Bytes) | Data Type |
| CPU | Identifier | 10 | String |
| CPU | Number | 1 | Unsigned |
| | | | Integer |
| RAM | Total Capacity | 2 | Unsigned |
| | | | Integer |
| RAM | Number of | 1 | Unsigned |
| | Modules | | Integer |
| Hard Disk | Total Capacity | 2 | Unsigned |
| Drive | | | Integer |
| Hard Disk | Identifier | 8 | String |
| Drive | | | |
| Hard Disk | Number | 1 | Unsigned |
| Drive | | | Integer |
| Expansion Card | Total Number | 1 | Unsigned |
| | | | Integer |
| PCIe Adaptor | Manufacturer | 2 | Unsigned |
| | Identifier | | Integer |
| PCIe Adaptor | Hardware | 2 | Unsigned |
| | Identifier | | Integer |
| PCIe Adaptor | Class Code | 3 | Unsigned |
| | | | Integer |

For instance, an identifier of the CPU may be “Intel Xeon Processor E5-2440” that includes the make and model. “Unsigned” signifies there are no negative values. The total capacity of the (volatile) RAM and the hard disk drives may be expressed in gigabytes to save space in the reserved storage place. The class code of PCIe (Peripheral Component Interconnect Express) Adaptor is used to identify the purpose of a component. Some entries in Table 1 may be repeated. There could be multiple “hard disk drive-identifier” entries corresponding to the existence of several hard disk drives, or sets of PCIe adaptor parameters if there was more than one expansion card. Any person skilled in the art should be able to freely define a format for HCD generation and parsing.

To summarize the present invention, the BIOS as the main actor accesses the current and the preset HCD through the BMC, replaces the latter with the former based on comparison results (such as hardware errors or a difference in the number of components between the two), and selectively records the results still through the BMC. Monitoring and managing server hardware configuration become more efficient and convenient. The HCD following a user-defined format is able to accommodate hardware cannot be covered by SMBIOS and contributes to decreasing the obfuscation of the information therein.

What is claimed is:

1. A server inspecting method comprising:
starting up a server;
performing, by a basic input/output system (BIOS) of the server, a power-on self-test of the server to generate current hardware configuration data of the server;
obtaining, by the BIOS, preset hardware configuration data from a field-replaceable unit (FRU) of the server through a baseboard management controller (BMC) of the server, wherein the FRU is coupled with the BMC; and
determining, by the BIOS, whether the current hardware configuration data and the preset hardware configuration data match.

2. The server inspecting method of claim 1, wherein a storage place for storing the preset hardware configuration data is reserved in the FRU.

3. The server inspecting method of claim 2, further comprising:
determining, by the BIOS, whether the FRU stores the preset hardware configuration data;
wherein when the FRU does not store the preset hardware configuration data, the BIOS stores the current hardware configuration data into the storage place.

4. The server inspecting method of claim 2, wherein when the current hardware configuration data and the preset hardware configuration data have at least one mismatch, the BIOS stores the current hardware configuration data into the storage place, replacing the preset hardware configuration data with the current hardware configuration data.

5. The server inspecting method of claim 1, wherein when the current hardware configuration data and the preset hardware configuration data have at least one mismatch, the BIOS records the mismatch into an event log through the BMC.

6. A server comprising:
a baseboard management controller (BMC) capable of causing the server to start up;
a field-replaceable unit (FRU), coupled with the BMC, for storing preset hardware configuration data; and
a basic input/output system (BIOS) for performing a power-on self-test of the server to generate current hardware configuration data of the server, obtaining preset hardware configuration data from the FRU through the BMC, and determining whether the current hardware configuration data and the preset hardware configuration data match.

7. The server of claim 6, wherein a storage place for storing the preset hardware configuration data is reserved in the FRU.

8. The server of claim 7, wherein the BIOS is further adapted for determining whether the FRU stores the preset hardware configuration data, and when the FRU does not store the preset hardware configuration data, the BIOS stores the current hardware configuration data into the storage place.

9. The server of claim 7, wherein when the current hardware configuration data and the preset hardware configuration data have at least one mismatch, the BIOS stores the current hardware configuration data into the storage place, replacing the preset hardware configuration data with the current hardware configuration data.

10. The server of claim 6, wherein when the current hardware configuration data and the preset hardware configuration data have at least one mismatch, the BIOS records the mismatch into an event log through the BMC.
